(19) United States
(12) Patent Application Publication
(10) Pub. No.: US 2023/0205518 A1
(43) Pub. Date: Jun. 29, 2023

(54) MANAGEMENT METHOD AND MANAGEMENT SYSTEM USED FOR REDUCING VERSION DEPENDENCY

(71) Applicant: QNAP SYSTEMS, INC., New Taipei City (TW)

(72) Inventor: Chia-En Wu, New Taipei City (TW)

(73) Assignee: QNAP SYSTEMS, INC., New Taipei City (TW)

(21) Appl. No.: 18/090,501

(22) Filed: Dec. 29, 2022

(30) Foreign Application Priority Data
Dec. 29, 2021 (TW) 110149306

(51) Int. Cl. G06F 8/71

(52) U.S. Cl. CPC G06F 8/71

(57) ABSTRACT

A management method and a management system used for reducing version dependency are provided. In the method, a server software transmits an executable program code to one or more client software via a simplified interface in response to a function of the server software having a change and the client software being requested to receive the executable program code. The client software executes the executable program code, to realize the expected result of the function with the change. The client software keeps the version of the client software constant by setting a separation mechanism between the client software and the executable program code corresponding to the change of the function. The client software transmits response information via the simplified interface. The response information includes a result obtained after executing the executable program code.

### CROSS-REFERENCE TO RELATED APPLICATION

This application claims the priority benefit of Taiwan application serial no. 110149306, filed on Dec. 29, 2021. The entirety of the above-mentioned patent application is hereby incorporated by reference herein and made a part of this specification.

### BACKGROUND

### Technical Field

The disclosure relates to a software management technology, and more particularly, to a management method and a management system used for reducing version dependency.

### Description of Related Art

FIG. 1 is a schematic diagram of a client-server model in an application program. Referring to FIG. 1, there may be version dependency between a server software S and one or more client software C. A version of the client software C needs to upgrade to a specific version or a version within a version range according to a version of the server software S.

In general, in order to perform a version mapping on software, it needs to be completed through several specific interfaces. The interfaces are defined as requests and responses that meet respective requests. For example, FIG. 2 is a schematic diagram of an interface for a version mapping. Referring to FIG. 2, the server software S requests to respectively obtain CPU information, memory information, and storage information through three application programming interfaces (APIs) (also socket IOs). Inquiries for hardware information have already required three interfaces. It is conceivable that for an overall process of a version upgrade, more interfaces or programs are required to achieve the version upgrade.

### SUMMARY

In view of this, an embodiment of the disclosure provides a management method and a management system used for reducing version dependency, which may achieve a version mapping via a simplified interface.

A management method used for reducing version dependency in the embodiment of the disclosure includes (but is not limited to) the following steps. A server software transmits an executable program code to one or more client software via a simplified interface in response to a function of a server software having a change and the client software being requested to receive the executable program code. The client software executes the executable program code to realize the expected result of the function with the change. The client software keeps the version of the client software constant by setting a separation mechanism between the client software and the executable program code corresponding to the change of the function. The client software transmits response information via the simplified interface. The response information includes a result obtained by the client software executing the executable program code.

A management system used for reducing version dependency in the embodiment of the disclosure includes (but is not limited to) a server software and one or more client software.

Based on the above, according to the management method and the management system used for reducing version dependency in the embodiments of the disclosure, for any changes of the function of the server software and the corresponding request of the client software, the executable program code may be transmitted via the simplified interface, allowing the client software to execute the program code, so as to satisfy the request. In this way, even if the client software does not upgrade the version of the client software corresponding to the changes of the function of the server software (i.e., keeping the version of the client software constant), the expected result of the function of the server software could be achieved, thereby reducing the version dependency.

In order for the aforementioned features and advantages of the disclosure to be more comprehensible, embodiments accompanied with drawings are described in detail below.

### BRIEF DESCRIPTION OF THE DRAWINGS

FIG. 1 is a schematic diagram of a client-server model in an application program.

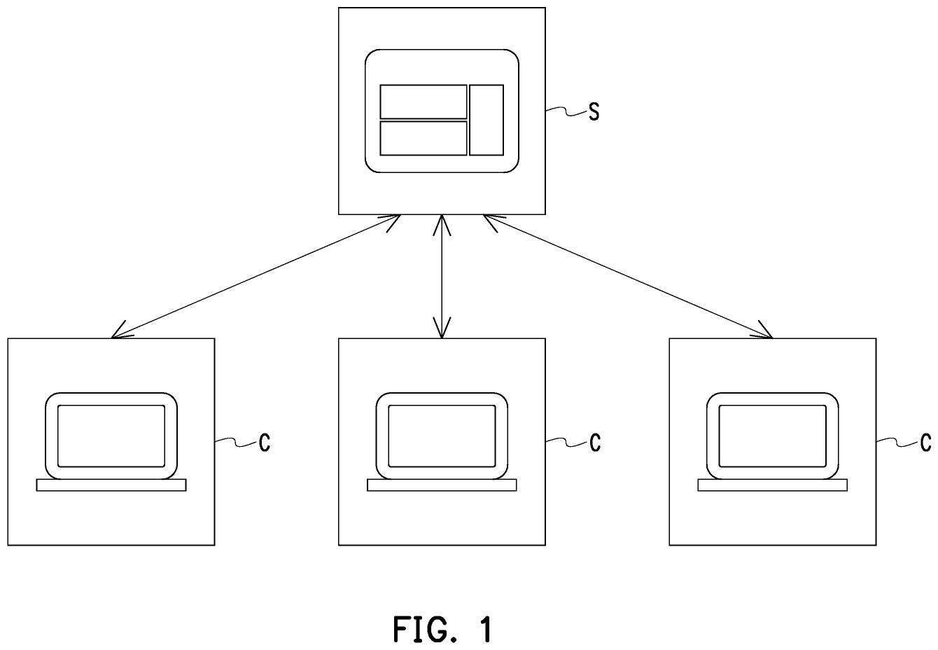

FIG. 2 is a schematic diagram of an interface for a version mapping.

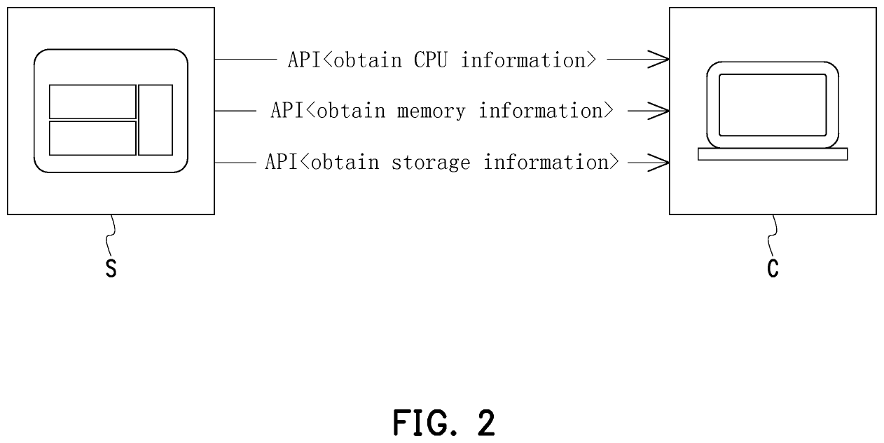

FIG. 3 is a block diagram of components of a management system according to an embodiment of the disclosure.

FIG. 4 is a schematic diagram of defining a simplified model according to an embodiment of the disclosure.

FIG. 5 is a schematic diagram of defining a simplified model according to an embodiment of the disclosure.

FIG. 6 is a flowchart of initializing a connection according to an embodiment of the disclosure.

FIG. 7 is a flowchart of a protocol definition according to an embodiment of the disclosure.

FIG. 8 is a flowchart of encryption according to an embodiment of the disclosure.

FIG. 9 is a flowchart of a task transfer under synchronization according to an embodiment of the disclosure.

FIG. 10 is a flowchart of a task transfer under non-synchronization according to an embodiment of the disclosure.

FIG. 11 is a flowchart of analysis according to an embodiment of the disclosure.

FIG. 12 is a schematic diagram of a comparison of a conventional version upgrade and a proposed method according to an embodiment of the disclosure.

FIG. 13 is a schematic diagram of cross-platform support according to an embodiment of the disclosure.

FIG. 14 is a flowchart of a management method used for reducing version dependency according to an embodiment of the disclosure.

### DETAILED DESCRIPTION OF DISCLOSED EMBODIMENTS

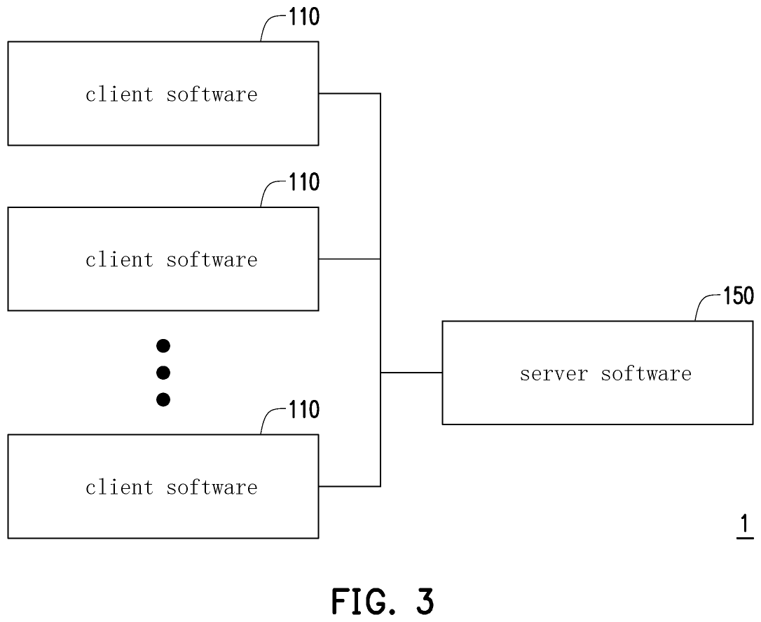

FIG. 3 is a block diagram of components of a management system according to an embodiment of the disclosure. Referring to FIG. 3, a management system 1 includes one or more client software 110 and a server software 150.

Types or contents of the client software 110 and the server software 150 may be changed according to actual requirements, and the embodiment of the disclosure is not limited thereto, for example, backup software, a web browser, or an image editor. Software may also be referred to as an application program, a package, or a software module.

The client software 110 and the server software 150 may run through one or more processors of the same or different computer systems, virtual machines, or containers. The processor may be a central processing unit (CPU), a graphic processing unit (GPU), other programmable general-purpose or special-purpose microprocessors, a digital signal processor (DSP), a programmable controller, a field programmable gate array (FPGA), an application-specific integrated circuit (ASIC), other similar components, or a combination of the above components.

Hereinafter, the method in the embodiment of the disclosure will be described with various components or modules in the management system 1. Each of the processes of the method may be adjusted according to the implementation, and is not limited thereto.

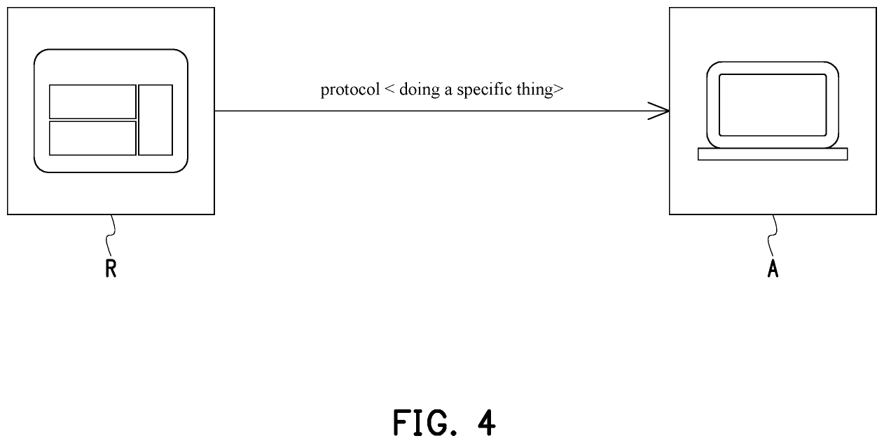

In an embodiment, the server software 150 may define and simplify an interface (or referred to as a simplified interface). The simplified interface may be an API, socket IO, or other programming communication interfaces. FIG. 4 is a schematic diagram of defining a simplified model according to an embodiment of the disclosure. Referring to FIG. 4, different from a conventional interface for upgrading, a protocol of the simplified interface includes first information and second information.

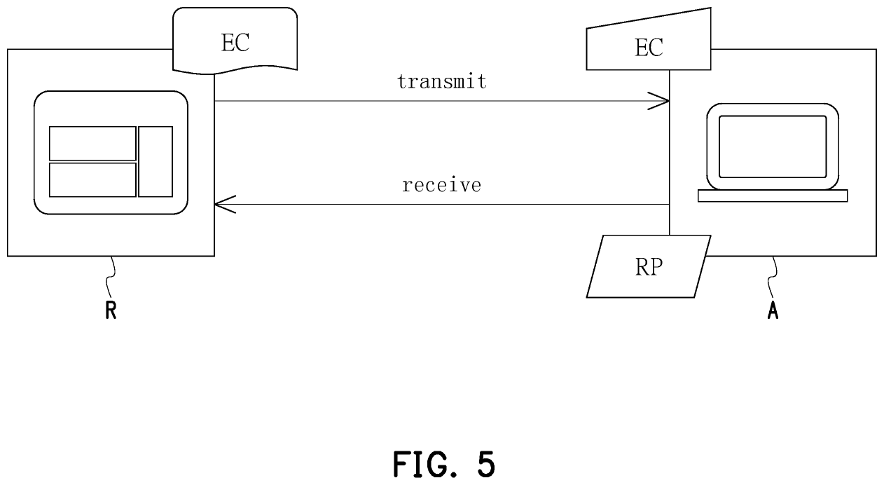

The first information is that a requester R provides an executable program code. The first information is used to indicate what to do. FIG. 5 is a schematic diagram of defining a simplified model according to an embodiment of the disclosure. Referring to FIG. 5, the first information in this embodiment is that the requester R may transmit one or more executable program codes EC (as files) to a receiver A. The executable program code is defined as a program code with a specific function, for example, uploading data, downloading data, or backing up data. A format of the executable program code depends on a platform, and an operating system or environment of the receiver A. For example, file extensions are “.exe”, “.App”, and “.run”, or metadata have executable permissions. In an embodiment, the server software 150 may be used as the requester R, and the client software may be used as the receiver A.

The second information is how the receiver A uses the executable program code. The second information is used to indicate how to do things. Referring to FIG. 5, the second information in this embodiment is that the receiver A executes the received executable program code to complete the specific function, and returns defined response information (for example, an execution result RP of the executable program code) to the requester R.

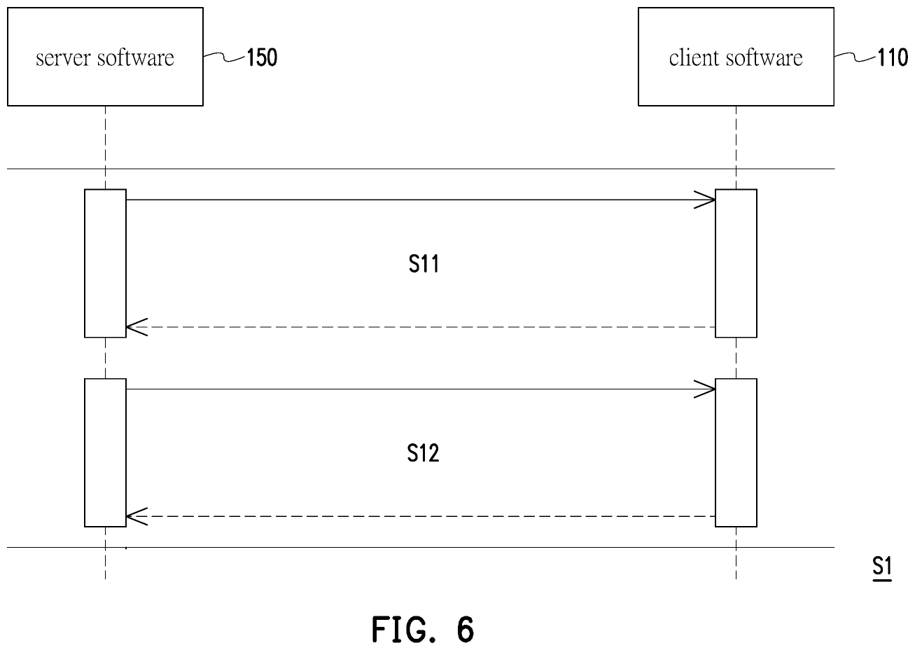

FIG. 6 is a flowchart of initializing a connection according to an embodiment of the disclosure. Referring to FIG. 6, in step S1 of initializing the connection, the server software 150 may establish a connection with the one or more client software 110 (step S11). In an embodiment, the server software 150 puts authorization with the connected client software 110 (step S12). If the authorization is successful, the client software 110 transmits an access token to the server software 150. The access token may be used for correctness or permission verification of subsequent data or files, and will be described in subsequent embodiments.

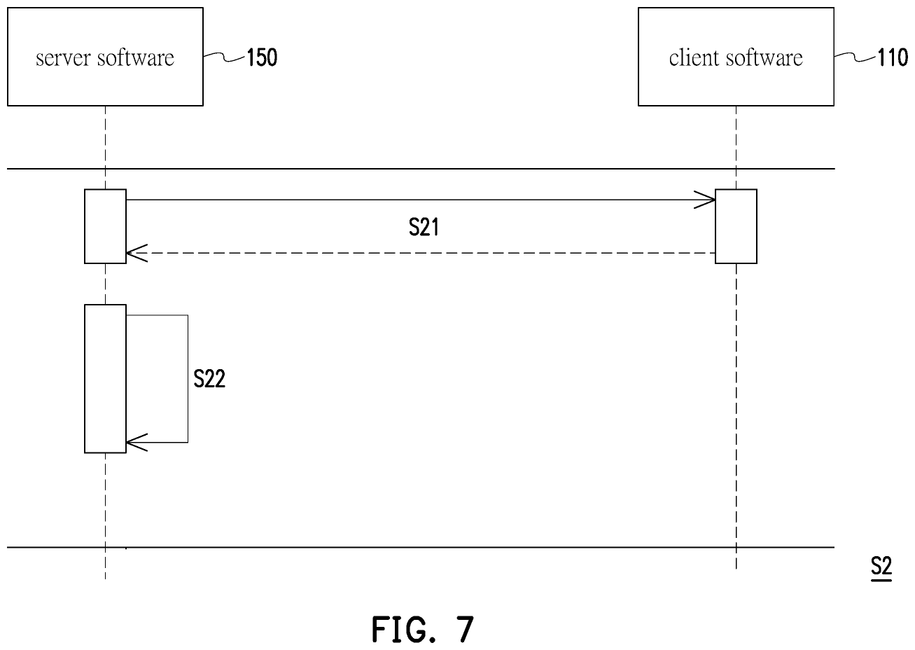

FIG. 7 is a flowchart of a protocol definition according to an embodiment of the disclosure. Referring to FIG. 7, in step S2 of the protocol definition, the server software 150 and the client software 110 may check a version of the simplified interface and/or the platform (or the operating system and execution environment) on which the simplified interface is located (step S21). The server software 150 may select the corresponding simplified interface according to an inspection result. Alternatively, if the version and/or the platform does not conform to rules, the server software 150 may cancel/interrupt/disable a task (step S22).

In an embodiment, the server software 150 may define a task model of the simplified interface. For example, for a task transfer model, the first information used for indicating what to do and the second information used for indicating how to do things are defined. This first information may be based on the platform or cross-platform software. In an embodiment, the second information may be more related to relevant parameters of the executable program code and an exit code. The parameters may be stored in a payload of a network packet.

In an embodiment, since a function of the server software 150 has a change (e.g., addition, removal, or other modifications), and the one or more client software 110 is requested (or has an executing request) for receiving the executable program code or providing of the function with the change, the server software 150 uses the simplified interface to perform processing corresponding to the change of the function. In other words, when the client software also requests to provide updates corresponding to the addition, modification, or removal (collectively referred to as changes) of the function of the server software 150, the expected result of the function with the changes may be realized in the client software via the simplified interface. That is, the requester R provides the executable program code via the simplified interface, and the receiver A executes the executable program code and returns the execution result.

In an embodiment, the executable program code is related to the function with the change. For example, if the change is adding a function, the function of addition may be operated by executing the executable program code. For another example, if the change is modifying a function, the function of modification may be operated by executing the executable program code.

In an embodiment, the simplified interface is also adapted for another change of the same function or another change of other functions. That is to say, when the client software also requests to received the executable program code or provide the updates corresponding to the addition, modification, or removal (collectively referred to as the changes) of the same or different functions of the server software 150, the expected result of the function with the changes may also be realized in the client software via the simplified interface. At this point, the executable program code is related to the other change or changes.

In an embodiment, for the task transfer model, the server software 150 may define an identification code of the executable program code according to the function with the change. The identification code represents an identity of the task model, and may be used by the server-side software 150 to track the status of the task model.

In an embodiment, for the task transfer model, the server software 150 may define one or more return codes of the executable program code. Each of the return codes represents a result of executing the executable program code, for example, success, failure, or a specific type of error. That is, the execution result is represented by coding. In an embodiment, the return code is related to the exit code.

In an embodiment, for the task transfer model, the server software 150 may define one or more result messages of the executable program code. Each of the result messages represents the result of executing the executable program code, for example, success, failure, or the specific type of error. That is, the execution result is represented by words or symbols.

In an embodiment, for a task return model, the server software 150 may define a receiving interface. The receiving interface is for the client software 110 to transmit the return codes and/or the result messages.

In an embodiment, for the task return model, the server software 150 may define analysis of the response information (e.g., the execution result of the executable program code), for example, how to analyze the return codes and/or the result messages.

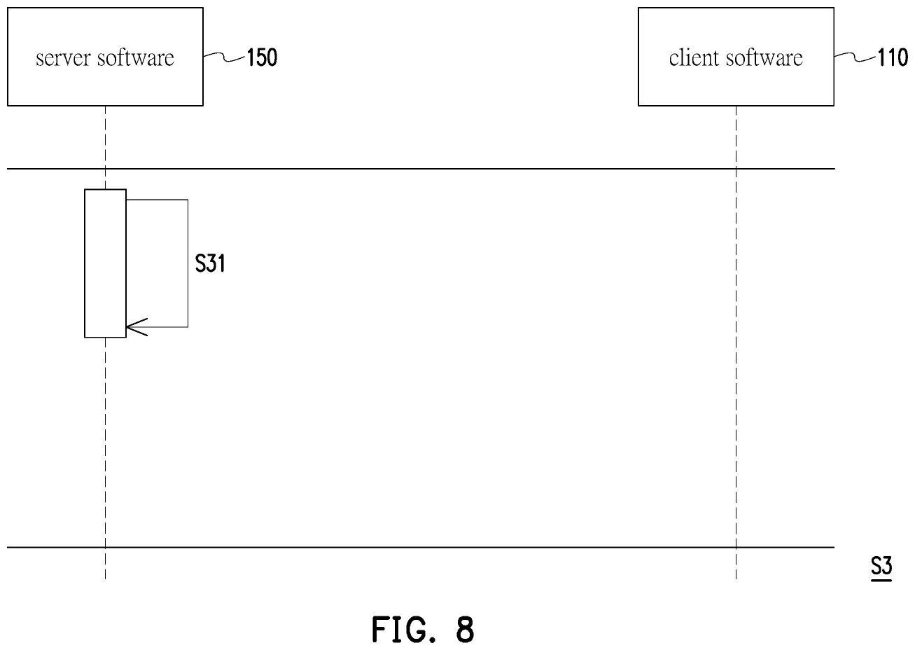

FIG. 8 is a flowchart of encryption according to an embodiment of the disclosure. Referring to FIG. 8, in step S3 of the encryption, the server software 150 encrypts a task content of the simplified model (step S31). The task content may be the executable program code. An encryption method may be symmetric encryption, a digital signature, a specific code, or other encryption mechanisms, and the embodiment of the disclosure is not limited thereto. In this way, it is possible to prevent others from tampering with or fraudulently using the executable program code.

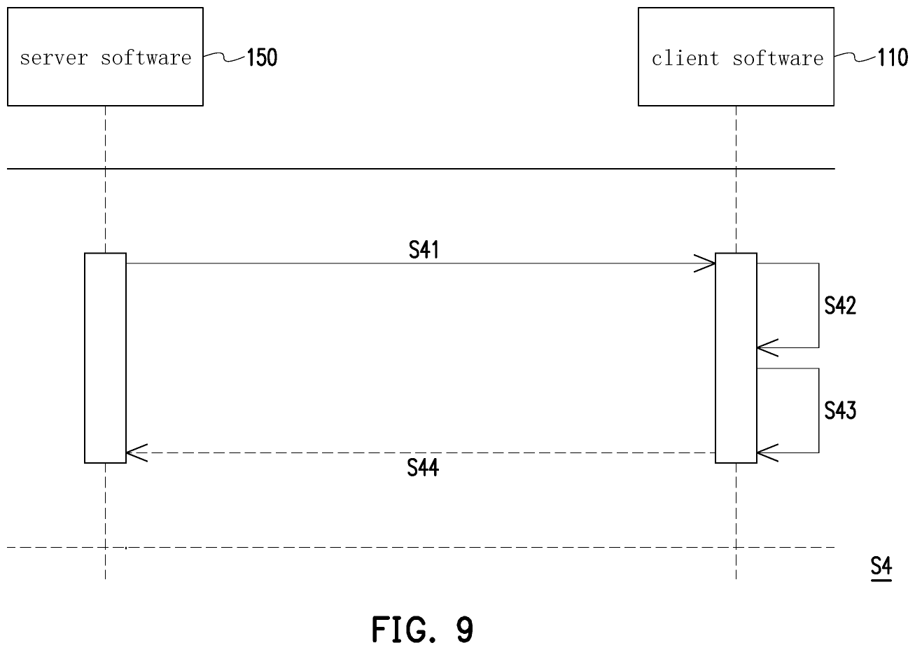

FIG. 9 is a flowchart of a task transfer under synchronization according to an embodiment of the disclosure. Referring to FIG. 9, in step S4 of the task transfer, the server software 150 may transmit the executable program code to one or more client software 110 via the simplified interface (step S41). The executable program code may or may not be encrypted. In an embodiment, the server software 150 may transmit the executable program code along with the access token to the client software 110. The client software 110 may verify a transmission object of the executable program code according to the access token. For example, the client software 110 determines whether the transmission object is the authorized server software 150 in an initial connection stage. For another example, a JSON Web token may be used for authorization, permissions, integrity, and encryption.

In an embodiment, if the executable program code is encrypted, the client software 110 may decrypt the executable program code (step S42). Next, the client software 110 executes the executable program code (step S43). If the executable program code corresponds to the change of the function, the client software may realize the expected result of the function with the change. In light of the above, the executable program code may satisfy the executing request of the client software 110, and the client software 110 would keep its version constant by setting a separation mechanism between the client software and the received executable program code corresponding to the change of the function of the server software. That is, the client software 110 does not upgrade the version of the client software corresponding to the change of the function. In other words, the client software 110 does not need to upgrade the version of the client software corresponding to the change of the server software 150, and an upgrading request of the client software 110 may be satisfied by the simplified interface.

In an embodiment, the client software 110 may obtain the executable program code from the file from the server software 150, and obtain the relevant parameters of the executable program code from a packet header. In another embodiment, the relevant parameters may also be stored in the payload of the network packet.

Next, the client software 110 transmits the response information to the server software via the simplified interface (step S44). The response information includes a result obtained by the client software 110 executing the executable program code. For example, the response information includes the return codes and/or the result messages.

In an embodiment, if the relevant parameters of the executable program code include a callback URL, the client software 110 may transmit the response information to the URL. In other embodiments, a destination location of the response information may also have other changes.

In an embodiment, the server software 150 uses a thread to wait for the response information from the client software 110. As shown in FIG. 9, after the server software 150 transmits the executable program code, the server software 150 waits for the corresponding response information, and receives the response information accordingly.

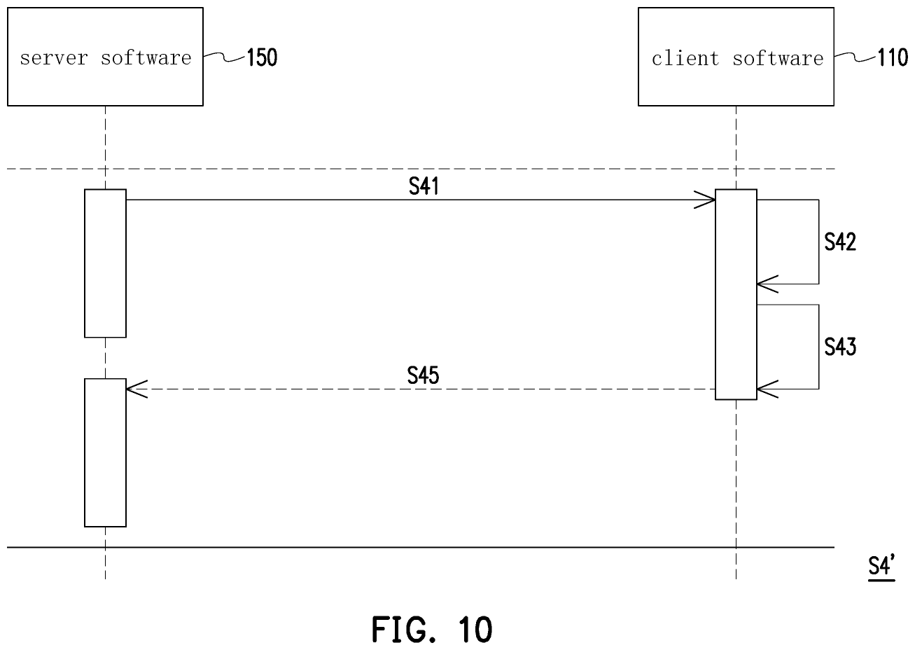

FIG. 10 is a flowchart of a task transfer under non-synchronization according to an embodiment of the disclosure. Referring to FIGS. 9 and 10, a difference from FIG. 9 is that in step S4′ of the task transfer, the simplified interface does not use the thread to wait for the response information. As shown in FIG. 10, the server software 150 does not need to wait for the corresponding response information after transmitting the executable program code. The client software 110 may transmit the execution result of the executable program code or the identification code of the task along with the response information to the server software 150 (step S45). For example, the response information further includes the identification code. Next, the server software 150 receives the response information, and confirms that the response information corresponds to the executable program code transmitted in step S41 according to the identification code.

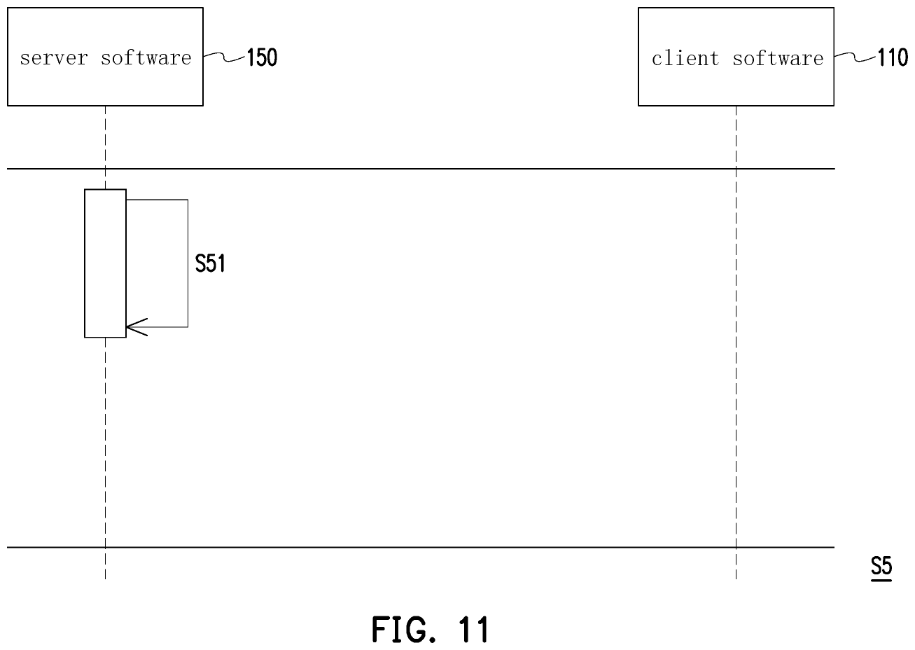

FIG. 11 is a flowchart of analysis according to an embodiment of the disclosure. Referring to FIG. 11, in step S5 of analysis, the server software 150 may analyze the response information from the client software 110 (step S51).

In an embodiment, the response information includes one of the one or more defined return codes. The server software 150 may analyze the result of the executable program code according to the received return code.

In an embodiment, the response information includes one of the one or more defined result messages. The server software 150 may analyze the result of the executable program code according to the received result message.

In some embodiments, the response information includes the return code and the result message. The server software 150 may analyze the result of the executable program code according to the received return code and the received result message.

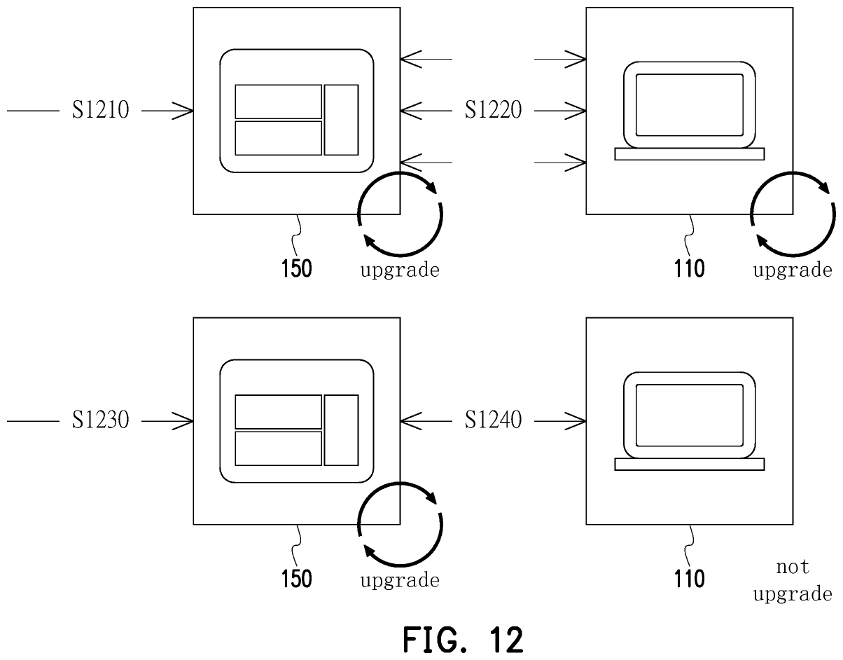

FIG. 12 is a schematic diagram of a comparison of a conventional version upgrade and a proposed method according to an embodiment of the disclosure. Referring to FIG. 12, in the conventional technology, if there are changes in new functions or fixed bugs (step S1210), both the client software 110 and the server-software 150 need to upgrade to a new version through multiple interfaces (step S1220). In the method proposed by the embodiment of the disclosure, if there are changes in the new functions or the fixed bugs (step S1230), the changes are integrated into the executable program code. Next, the server software 150 only needs to transmit the executable program code via the simplified interface, and the client software 110 executes the executable program code (step S1240). In the embodiment of the disclosure, only the server software 150 upgrades to the new version corresponding to the changes, but the client software 110 does not need to upgrade to the new version. In this way, the version dependency may be reduced.

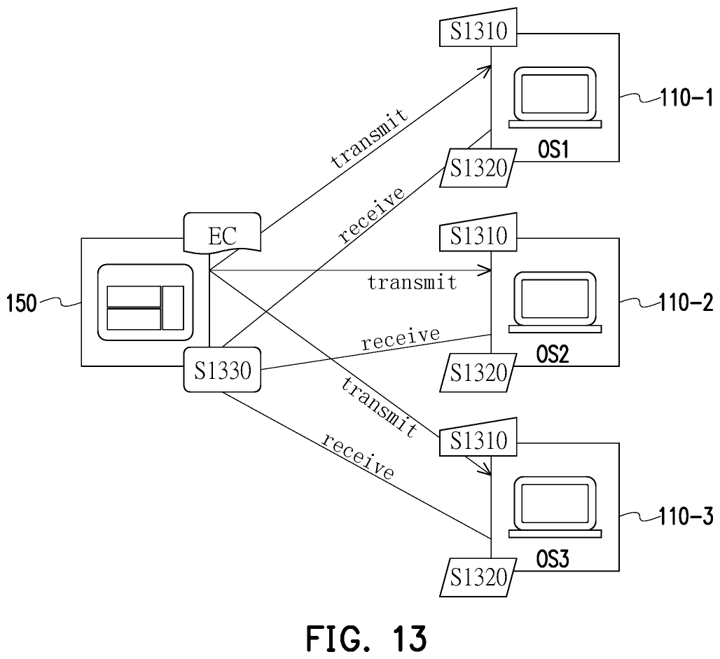

FIG. 13 is a schematic diagram of cross-platform support according to an embodiment of the disclosure. Referring to FIG. 13, the function of the server software 150 may be realized in a cross-platform executable program code. The server software 150 respectively generates and transmits the corresponding executable program codes EC according to platforms OS1, OS2, and OS3 where client software 110-1, 110-2, and 110-3 are located (step S1310). The executable program codes EC may run on the platforms OS1, OS2, OS3 respectively, and enable the client software 110-1, 110-2, and 110-3 to transmit the response information (step S1330). Next, the server software 150 may receive the response information from the client software 110-1, 110-2, and 110-3.

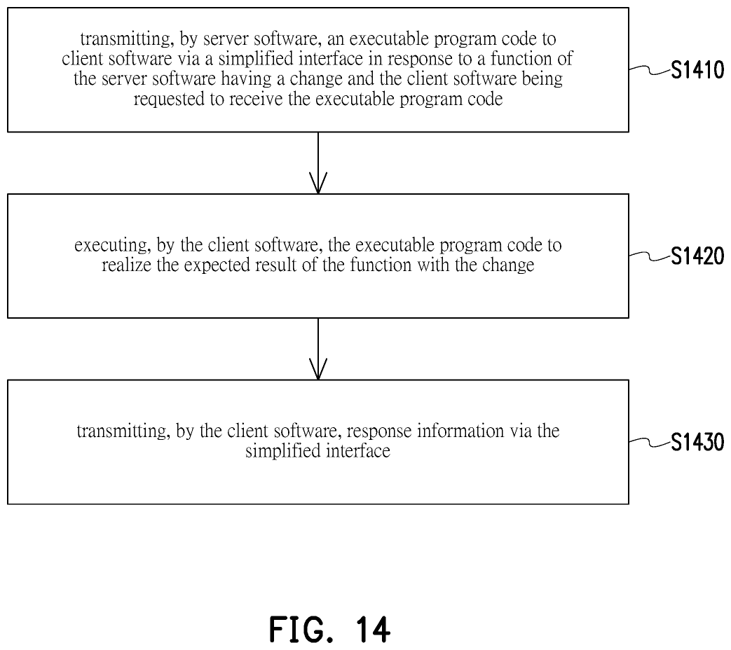

FIG. 14 is a flowchart of a management method used for reducing version dependency according to an embodiment of the disclosure. Referring to FIG. 14, the server software 150 transmits the executable program code to one or more client software 110 via the simplified interface in response to the function of the server software 150 having the change and the client software 110 being requested to receive the executable program code (step S1410). The simplified interface is also adapted for another change of the function. The client software executes the executable program code to realize the expected result of the function with the change (step S1420). The executable code satisfies the executing request. The client software keeps the version of the client software constant without upgrading by setting a separation mechanism between the client software and the received executable program code corresponding to the change of the function of the server software. The client software transmits the response information via the simplified interface (step S1430). The response information includes the result obtained by the client software executing the executable program code.

The detailed descriptions of steps S1410 to S1430 may refer to the descriptions of FIG. 3 to FIG. 13, and thus the same details will not be repeated in the following.

Based on the above, in the management method and the management system used for reducing version dependency according to the embodiments of the disclosure, the server software defines the simplified interface, the task model, or the executable program code, and the server software transmits the executable program code via the simplified interface and receives the execution result of the executable program code, and then analyze the execution result. When the server software has the request for providing the upgrades relative to the client software corresponding to the addition, modification, or removal of functions, the simplified interface is defined on the server software, and the executable program code is transmitted to the client software for execution via the simplified interface. The upgrading request may be satisfied by transmitting and receiving the executable program code via the simplified interface, so that the client software keeps the version of the client software constant by setting a separation mechanism between the client software and the executable program code. The executable program code is corresponding to the changes of the function of the server software. In other words, the client software does not upgrade the version of the client software corresponding to the changes of the function of the server software. In addition, after the client software executes the executable program code, it may return the execution result or the information of the executable program code to the server software, and the server software further analyzes the execution result or the information.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A management method used for reducing version dependency, comprising:
transmitting, by a server software, an executable program code to at least one client software via a simplified interface in response to a function of the server software having a change and the at least one client software being requested to receive the executable program code;
executing, by the at least one client software, the executable program code to realize an expected result of the function with the change, wherein the at least one client software keeps a version of the client software constant by setting a separation mechanism between the client software and the executable program code corresponding to the change of the function of the server software;
transmitting, by the at least one client software, response information via the simplified interface, wherein the response information comprises a result obtained by the at least one client software executing the executable program code; defining, by the server software, an identification code of the executable program code according to the function with the change; and
confirming, by the server software, that the response information corresponds to the executable program code according to the identification code, wherein the response information comprises the identification code.

2. The management method used for reducing version dependency according to claim 1, further comprising:
defining, by the server software, the simplified interface, wherein the simplified interface comprises first information and second information, the first information is that a requester provides the executable program code, and the second information is how a receiver uses the executable program code.

3. The management method used for reducing version dependency according to claim 1, further comprising:
defining, by the server software, at least one return code of the executable program code; and
analyzing, by the server software, a result of the executable program code according to one of the at least one return code, wherein the response information comprises one of the at least one return code.

4. The management method used for reducing version dependency according to claim 1, further comprising:
defining, by the server software, at least one result message of the executable program code; and
analyzing, by the server software, a result of the executable program code according to one of the at least one result message, wherein the response information comprises one of the at least one result message.

5. The management method used for reducing version dependency according to claim 1, further comprising:
transmitting, by the at least one client software, an access token to the server software, wherein transmitting, by the server software, the executable program code to the at least one client software via the simplified interface comprises:
transmitting, by the server software, the executable program code along with the access token to the at least one client software; and
verifying, by the at least one client software, the executable program code according to the access token.

6. The management method used for reducing version dependency according to claim 1, wherein transmitting, by the server software, the executable program code to the at least one client software via the simplified interface comprises:
encrypting, by the server software, the executable program code.

7. The management method used for reducing version dependency according to claim 1, wherein after transmitting, by the server software, the executable program code to the at least one client software via the simplified interface, the management method further comprises:
using, by the simplified interface, a thread to wait for the response information.

8. The management method used for reducing version dependency according to claim 1, wherein after transmitting, by the server software, the executable program code to the at least one client software via the simplified interface, the management method further comprises:
not using, by the simplified interface, a thread to wait for the response information.

9. A management system used for reducing version dependency, comprising:
a server software; and
at least one client software, wherein
the server software transmits an executable program code to the at least one client software via a simplified interface in response to a function of the server software having a change and the at least one client software being requested to receive the executable program code;
the at least one client software executes the executable program code to realize an expected result of the function with the change, and the at least one client software keeps a version of the client software constant by setting a separation mechanism between the client software and the executable program code corresponding to the change of the function of the server software;
the at least one client software transmits response information via the simplified interface, the response information comprises a result obtained by the at least one client software executing the executable program code; and
the server software defines an identification code of the executable program code according to the function with the change, and the server software confirms that the response information corresponds to the executable program code according to the identification code, and the response information comprises the identification code.

10. The management system used for reducing version dependency according to claim 9, wherein the server software defines the simplified interface, wherein the simplified interface comprises first information and second information, the first information is that a requester provides the executable program code, and the second information is how a receiver uses the executable program code.

11. The management system used for reducing version dependency according to claim 9, wherein the server software defines an identification code of the executable program code according to the function with the change, the server software confirms that the response information corresponds to the executable program code according to the identification code, and the response information comprises the identification code.

12. The management system used for reducing version dependency according to claim 9, wherein the server software defines at least one result message of the executable program code, the server software analyzes a result of the executable program code according to one of the at least one result message, and the response information comprises one of the at least one result message.

13. The management system used for reducing version dependency according to claim 9, wherein the at least one client software transmits an access token to the server software, the server software transmits the executable program code along with the access token to the at least one client software, and the at least one client software verifies the executable program code according to the access token.

14. The management system used for reducing version dependency according to claim 9, wherein the server software encrypts the executable program code.

15. The management system used for reducing version dependency according to claim 9, wherein the simplified interface uses a thread to wait for the response information.

16. The management system used for reducing version dependency according to claim 9, wherein the simplified interface does not use a thread to wait for the response information.
